(19) United States
(12) Patent Application Publication
(10) Pub. No.: US 2007/0112093 A1
(43) Pub. Date: May 17, 2007

(54) Priming agent-orthogonal selection of moiety and basic film forming resin

(76) Inventors: Yaacov Almog, Nes Ziona (IL); Sergio Brandiss, Rehovot (IL); Amnon Levi, Gedera (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/564,591

(22) PCT Filed: Jul. 16, 2003
(86) PCT No.: PCT/IL03/00588

§ 371 Date: Jan. 13, 2006

(51) Int. Cl. C09D 11/00

(52) U.S. Cl. 523/160; 523/161

(57) ABSTRACT

A method of producing a sheet of coated substrate, comprising: providing a substrate; providing a solution or dispersion of a first material that adheres to the substrate mixed with an amine terminated material; coating the provided substrate with the solution; and drying the substrate coated with the solution to form a solid coating thereon.

### FIELD OF THE INVENTION

This invention is concerned with printing and more particularly with methods for producing substrates for use in liquid toner printing.

### BACKGROUND OF THE INVENTION

Primers or binders are generally necessary when printing with liquid toners on some plastic materials, such as PET, polycarbonate or other substrates. Without binders, such toners do not adhere well to the surface to be printed upon. Thus, a binder material is needed that has a high affinity for both the toner and the plastic. In the past, solvent based primers were generally used. However, the solvents in use are not environmentally friendly and are therefore commercially problematic.

However, it is difficult to provide a primer that is environmentally friendly and nonetheless has a high affinity for both the toner and the plastic. In general, it has been found that binders which are applied dissolved in solvents, which evaporate and leave a cured binder work best for this task. Such binders are generally acrylates. However, such primer systems do cause air pollution when the solvents evaporate.

Primers which are UV cured and/or applied in an aqueous solution are advantageous since they are non-polluting. Acrylic based monomers are known for use as UV cured binders. It is known to use hydrolized PVA (applied as an aqueous solution) for a binder. However, such binders, while they adhere well to plastic substrates, do not adhere well to toners such as those based on Nucrel (coplymers of ethylene and an alpha, beta ethelenically susaturated acid of either acrylic or metacrylic acid supplied by E. I. du Pont) and Surlyn (ionomer resins by E. I. du Pont) polymers. Such polymer based toners are sold, for example, by Hewlett-Packard under the trade name ElectroInk. The ElectroInk brand toners comprise pigmented polymer particles, a carrier liquid such as a Isopar (solvent of branched-chain aliphatic hydrocarbons and mixtures thereof, e.g., isoparapffinic hydrocarbon fractions by EXXON) or Marcol (highly refined petroleum oils by EXXON).

WO 01/22172, the disclosure of which is incorporated herein by reference, describes a coating for plastic substrates in which a monomer is mixed with a nanosilica material and, in some embodiments, an anchorage agent and cured to form a coating. After coating, a UV cure is performed to form a cured coating. Examples of disclosed monomers are acrylic based UV curable monomers with mono, di and tri functionality such as UV curable water soluble hydrolized PVA. Examples of anchorage agents are amine materials, such as diamine terminated polyoxyethelene, diamine, triamine or monoamine terminated Polypropylene oxide. Other anchorage agents can also be used, especially those with an amino terminated polymer backbone.

### SUMMARY OF THE INVENTION

An aspect of the invention is concerned with coating a substrate with a coating that comprises an amine, together with a binder material, without the need for polymerization of the binder material on the substrate. Thus, the binder material need only be dried in order to coat the substrate with the amine incorporated into the matrix of the binder.

In some embodiments of the invention, the binder materials are materials which adhere well to the substrate, but which do not bind well to the liquid toner materials. As indicated above, there are few, if any, materials which adhere well to both the substrate and the toner. Adhesion to the toner materials is provided by the amine, so that a wide range of binder materials can be used. Some example of such binders include partly or nearly fully hydrolyzed PVA, styrene-butadine coplymer and acrylic ester copolymers.

The present invention can be practiced with a range of plastic substrates, including, for example, PET and polypropylene.

In various embodiment of the invention, anchorage agents such as an amine material, especially diamine terminated polyoxyethelene, diamine, triamine or monoamine terminated Polypropylene oxide (PPO), are added to the binder coatings to increase their adhesion to the toner materials. Other anchorage agents can also be used, especially those with an amino terminated polymer backbone.

It should be noted that while diamine terminated PPO is more effective than mono or tri-amine terminated PPO, this may be due to the fact that diamine terminated PPO has a higher degree of basicity, i.e., the basic equivalent per gram of material (milli equivalent/gm or meq/grn), measured by its ability to neutralize an acid such as HCl is greatest for the diamine terminated material.

Furthermore, while the backbone to which the amine is attached is not believed to be critical, the basicity is believed to be important.

There is thus provided, in accordance with an exemplary embodiment of the invention, a method of producing a sheet of coated substrate, comprising:

providing a substrate;

providing a solution or dispersion of a first material that adheres to the substrate mixed with an amine terminated material;

coating the provided substrate with the solution; and

drying the substrate coated with the solution to form a solid coating thereon.

In various embodiments of the invention, the amine terminated material is a diamine terminated material, a monoamine terminated material or a tri-amine terminated material.

Optionally, the amine terminated material is diamine poly (propylene oxide).

Optionally, the amine terminated material is mono-amine poly (propylene oxide).

Optionally, the amine terminated material is tri-amine poly (propylene oxide).

Optionally, the first material comprises polyvinyl alcohol.

Optionally, the first material comprises a styrene-butadiene copolymer.

Optionally, the first material comprises an acrylic ester copolymer.

In various embodiments of the invention, the substrate comprises PET or polypropylene.

In an embodiment of the invention, the solution or dispersion also comprises sodium hydroxide.

Optionally the dry weight of amine terminated material is between 5 and 30% of the dry weight of the coating. Optionally, the dry weight of amine terminated material is 10% or more of the dry weight of the coating. Optionally, the dry weight of amine terminated material is 15% or more of the dry weight of the coating. Optionally, the dry weight of amine terminated material is 25% or less of the dry weight of the coating.

There is further provided a coated sheet produced according to the method of the invention.

There is further provided a printed sheet comprising a coated sheet produced according to the method of the invention; and an image printed on the sheet. Optionally the image is printed using a liquid toner process.

There is further provided, in accordance with an embodiment of the invention, a method of printing comprising:

providing a coated substrate according to the invention or produced according to a method of the invention;

printing an image on the coating using a liquid toner; and

fixing the image to the coated substrate,

wherein the adhesion of the liquid toner image to the substrate is improved over its adhesion to a similarly coated substrate in which the coating does not include the amine terminated material.

In an embodiment of the invention, the substrate and the pigmented particles are both acidic.

In an embodiment of the invention, the coating forms a substantially smooth surface.

Optionally, the substrate is a CD or DVD disk.

### DETAILED DESCRIPTION OF PREFERRED EMBODIMENTS

The present invention is believed to be applicable to a wide range of binder materials, substrates and toner materials. Some representative, non-limiting, examples of the application of the present invention follow.

### CONTROL A AND EXAMPLES A1 AND A2

90 grams of a 10% solution of PVA 87-89% hydrolyzed, having a molecular weight of 124,000-186,000 (Aldrich Chemical, Inc., Milwaukee, Wis., USA) is mixed with 10 grams of a 1N solution of NaOH. This solution has a 4% by weight of NaOH. This solution is used as control A. To the solution are added 1 gram of diamine terminated Poly(propylene oxide) (PPO), having an amine content of 8.45 meq/gram. (Scientific Polymer Products, Inc., N.Y. USA) to form the coating solution for example A1. 2 grams of the diamine terminated PPO is added to the control solution to form the coating solution for example A2.

The coating is applied to a PET transparency, using wire rod on a Byk-Gardner coating machine and dried using hot air Neither the temperature nor the time appear to be critical and a blower was used in experiments described herein. A 5 micrometer dry layer was produced. However, this value can also vary within a substantial range.

### CONTROL B AND EXAMPLES B1 and B2

The same procedure and materials used in control A and Examples A1 and A2 is used, except that the 90 grams of a 10% solution of PVA 87-89% hydrolyzed, having a molecular weight of 124,000-186,000 (Aldrich Chemical, Inc., Milwaukee, Wis., USA) is replaced by 90 grams of 10% solution of PVA 75% hydrolyzed, having a molecular weight of 2000.

### CONTROL C AND EXAMPLES C1 and C2

The same procedure and materials used in control A and Examples Al and A2 is used, except that the 90 grams of a 10% solution of PVA 87-89% hydrolyzed, having a molecular weight of 124,000-186,000 (Aldrich Chemical, Inc., Milwaukee, Wis., USA) is replaced by an anionic dispersion of styrene-butadine coplymer having a 50% solids content (Marketed by BASF, Ludwigshafen, Germany under the trade name of Styronol), reduced by the addition of water to 10%.

### CONTROL D AND EXAMPLES D1 and D2

The same procedure and materials used in control A and Examples A1 and A2 is used, except that the 90 grams of a 10% solution of PVA 87-89% hydrolyzed, having a molecular weight of 124,000-186,000 (Aldrich Chemical, Inc., Milwaukee, Wis., USA) is replaced by an acqueous solution of acrylic ester coplymers having a 50% solids content (Marketed by BASF, Ludwigshafen, Germany under the trade name of Acronal PR8689), reduced by the addition of water to 10%.

Each of the substrates produced according to the controls described above was printed on an H-P Indigo Multistream “one shot press” marketed by Hewlett Packard Company, using Indigo/HP Series 1 inks at standard print settings. Patches of Cyan, Magenta, Yellow and Black inks having 100% coverage and 20% coverage were printed. The printed patches were tested for both ink transfer from the intermediate transfer blanket and adhesion of the printed material to coated substrate. Each of these measures describes a different aspect of attraction/adhesion of the toner to the substrate. The fixing measure is also a measure of the adhesion of the coating to the substrate. The following results were noted:

| SAMPLE | TRANSFER | FIXING |
|---|---|---|
| A | Poor (100% coverage) | Poor |
| A1 | Good | Good |
| A2 | Excellent | Good |
| B | Fair | Poor |
| B1 | Good | Good |
| B2 | Excellent | Good |
| C | Good | Poor |
| C1 | Excellent | Fair-Good |
| C2 | Excellent | Good |
| D | Poor | Poor |
| D1 | Fair | Fair |
| D2 | Fair-Good | Fair |

It is thus seen that using the diamine anchorage agent improves both transfer to the substrate and the strength of the bond of the printed image to the substrate. It is noted, with limiting the scope of the invention, that the image is fused to the substrate during transfer under pressure and at an intermediate transfer member temperature of about 135° C. However, other methods of transfer and fixing are expected to give similar comparable improvements. For example, the coated substrates of the invention are believed to work well for fixing images directly transferred to the substrate from a photoreceptor. In such cases, fusing and fixing of the image is provided separately from the transfer to the substrate.

The transfer quality measure is one or both of a visual inspection of the amount of material left on the intermediate transfer member and the quality of the image transferred. The adhesion test is a standard test performed by adhering a piece of 3M type 230 drafting tape to the printed image and then lifting the tape.

Furthermore, while the examples utilize diamine terminated PPO, it is believed that tri-amine and monoamine terminated PPO and mono-, di- and triamine terminated materials with other backbones also improve the adhesion, to a greater or lesser degree.

Additionally, the efficacy of the invention has been shown with coatings of PVA, Styronal and Acronal. However, it is believed that substantial improvements in adhesion can be achieved for other coatings that adhere well to the substrate, even if transfer to and fixing on these coating is poor without the addition of the amine terminated material.

Often, toner materials do not adhere to a substrate when both the toner and the substrate are acidic. This is the case with the toner used in these experiments and the substrates mentioned above. However, there are few basic coatings that adhere well to both the substrate and the toner. The amine terminated adhesion promoting additives allows for the use of coatings which adhere well to the substrates, without excessive concern for their adhesion vis-à-vis the toner, which is provided by the amine terminated material. This freedom allows for improved adhesion of the coating to both the toner and the substrate.

This freedom of choice of the coating material allows for use of binders that have specific, desired properties, such as a desired tackiness, a desired friction coefficient. Coatings with a range of electrical conductivities, including conducting coating can be provided, if the coating material is conductive.

The present invention has been described with reference to the best mode for carrying out the invention known to the inventors at the time of filing and using toner and printing systems which are readily available to them. It should be understood that the present invention is believed to be applicable to a wide variety of toners, binders and substrate. As used herein, the terms “include” “have” and “comprise” and their conjugates mean “including but not necessarily limited to”.

1. A method of producing a sheet of coated substrate, comprising:
providing a substrate;
providing a solution or dispersion of a first material that adheres to the substrate mixed with an amine terminated material;
coating the provided substrate with the solution; and
drying the substrate coated with the solution to form a solid coating thereon.

2. A method according to claim 1 wherein the amine terminated material is a diamine terminated material.

3. A method according to claim 1 wherein the amine terminated material is a monoamine terminated material.

4. A method according to claim 1 wherein the amine terminated material is a tri-amine terminated material.

5. A method according to claim 2 wherein the amine terminated material is diamine poly (propylene oxide).

6. A method according to claim 3 wherein the amine terminated material is mono-amine poly (propylene oxide).

7. A method according to claim 4 wherein the amine terminated material is tri-amine poly (propylene oxide).

8. A method according to claim 1 wherein the first material comprises polyvinyl alcohol.

9. A method according to claim 1 wherein the first material comprises a styrene-butadiene copolymer.

10. A method according to claim 1 wherein the first material comprises an acrylic ester copolymer.

11. A method according to claim 1 wherein the substrate comprises PET.

12. A method according to claim 1 wherein the substrate comprises polypropylene.

13. A method according to claim 1 wherein the solution or dispersion also comprises sodium hydroxide.

14. A method according to claim 1 wherein the dry weight of amine terminated material is between 5 and 30% of the dry weight of the coating.

15. A method according to claim 14 wherein the dry weight of amine terminated material is 10% or more of the dry weight of the coating.

16. A method according to claim 14 wherein the weight of amine terminated material is 20 15% or more of the dry weight of the coating.

17. A method according to claim 14 wherein the dry weight of amine terminated material is 25% or less of the dry weight of the coating.

18. A coated substrate produced according to the method of claim 1.

19. A printed sheet comprising: a coated sheet produced according to the method of claim 1; and an image printed on the sheet.

20. A printed sheet according to claim 19 wherein the image is printed using a liquid toner process.

21. A method of printing comprising:
providing a coated substrate according to claim 18;
printing an image on the coating using a liquid toner; and
fixing the image to the coated substrate,
wherein the adhesion of the liquid toner image to the substrate is improved over its adhesion to a similarly coated substrate in which the coating does not include the amine terminated material.

22. A printing method according to claim 21 wherein the substrate and the pigmented particles are both acidic.

23. A printing method according to claim 21 wherein the coating forms a substantially smooth surface.

24. A printing method according to claim 21 wherein the substrate is a CD or DVD disk.
